(19) United States
(12) Patent Application Publication
(10) Pub. No.: US 2012/0233975 A1
(43) Pub. Date: Sep. 20, 2012

(54) Lawnmowers

(75) Inventor: Adrian Coussins, Stowmarket (GB)

(73) Assignee: Robert Bosch GmbH, Stuttgart (DE)

(21) Appl. No.: 13/419,403

(22) Filed: Mar. 13, 2012

(30) Foreign Application Priority Data
Mar. 14, 2011 (EP) 11157994.2

(51) Int. Cl. A01D 34/00

(52) U.S. Cl. 56/320.2

(57) ABSTRACT

Lawnmowers, in particular walk-behind lawnmowers, have a mulching function. A lawnmower discharge deflector guard for a lawnmower has a cutter blade rotatably mounted within a cutting cavity. The cutting cavity is in communication with a discharge chute and has a discharge chute outlet formed in a face of the lawnmower closable by a closure flap. The guard is configured for demountable attachment to the lawnmower adjacent the discharge chute outlet to enclose the outlet and receive, in use, grass cuttings therefrom. The guard forms a substantially air/grass cutting-tight seal with the face of the lawnmower. The guard has an operative inner surface having a substantially vertical portion forming a discharge aperture with the face of the lawnmower and extending below a cutting height of the lawnmower. A lawnmower incorporating the guard is also described.

This application claims priority under 35 U.S.C. §119 to patent application no. EP 11157994.2, filed on Mar. 14, 2011 in Europe, the disclosure of which is incorporated herein by reference in its entirety.

### BACKGROUND

The present disclosure relates to lawnmowers, in particular to walk-behind lawnmowers having a mulching function.

More particularly, the present disclosure relates to the return of the grass clippings created by a lawnmower, such as a rotary lawnmower in which a cutter blade is caused to rotate within an cutter bowl on the underside of the mower, back into the lawn, thus avoiding the requirement for the user to collect and then dispose of the collected clippings. Loss of fertility from the lawn being cut, the physical task and time spent emptying the grassbag or box and environmental issues associated with disposal of the collected clippings are all avoided.

Many lawnmowers (so-called collecting mowers) are fitted with a collection device in the form of a grassbox or bag to collect the clippings from a discharge chute which is in communication with the cutter bowl. Many of these lawnmowers can be used without the collection device fitted, so that once cut grass has passed through the discharge chute it is deflected by a guard downwards onto the grass surface.

A further solution to this problem has resulted in the development of so-called mulching mowers. These machines do not have a discharge chute through which the clippings are directed to a collection device. Instead, cut grass is recirculated within the cutter bowl. Discharge of finely divided grass clippings takes place at the periphery of the blade, between the underside of the machine and the lawn.

Recent years have seen the development of combined mowers in which a plug is fittable into the discharge chute of a collecting mower, closing it and thereby forcing the cut material to be recirculated within the bowl and discharged in a manner similar to mulching mowers.

However, mulching mowers or collecting mowers operating in non-collect mode, leave the clippings on top of the grass which has just been cut, making it highly visible. As the grass clippings die off, the appearance of the lawn is affected. The appearance problem is exacerbated when the grass clippings are not evenly spread over the lawn, as can particularly occur when the grass is damp. Clippings can be deposited in swaths or the clippings can accumulate within the bowl, occasionally being released in a clump.

Furthermore, mulching mowers or collecting mowers fitted with a plug blocking the discharge chute do not work properly if set at too low height of cut.

Accordingly, there are at least three problems associated with existing solutions to the process of returning cut grass clippings created by rotary mowers into the lawn. Features of the disclosure seek to provide a solution to these problems.

### SUMMARY

In its broadest sense, the present disclosure provides a lawnmower discharge deflector guard for a lawnmower having a cutter blade rotatably mounted within a cutting cavity, wherein the cutting cavity is in communication with a discharge chute and having a discharge chute outlet formed in a face of the lawnmower obstructable by means of a closure flap; wherein the guard is adapted for demountable attachment to the lawnmower adjacent the discharge chute outlet to enclose said outlet and receive, in use, grass cuttings therefrom, wherein the guard forms a substantially air/grass cutting-tight seal with said face of the lawnmower; and wherein the guard has an operatively inner surface having a substantially vertical portion forming a discharge aperture with said face of the lawnmower and extending below a cutting height of the lawnmower.

The present disclosure also provides a lawnmower comprising a rotatable cutter blade mounted within a cutting cavity and a discharge chute having an inlet in communication with the cutting cavity and discharge chute outlet formed in a face of the lawnmower and obstructable by means of a closure flap; wherein the lawnmower further comprises a discharge deflector guard mountable adjacent the discharge chute outlet to enclose said outlet and receive, in use, grass cuttings therefrom, wherein the deflector guard forms a substantially air/grass cutting-tight seal with said face of the lawnmower; and wherein the guard has an operatively inner surface having a substantially vertical portion forming a discharge aperture with said face of the lawnmower and extending below a cutting height of the lawnmower.

Preferably, the inner surface of the guard forms a substantially continuous surface with an upper surface of discharge chute.

Preferably, the substantially vertical portion extends to a distance S below a level of the cutter blade, wherein S is at least 5 mm, preferably at least 10 mm, more preferably about 15 mm or more. Most preferably, S is about 18 mm.

Preferably, the substantially vertical portion comprises a skirt having a flange at a lowermost edge thereof.

Preferably, the guard comprises a pair of side walls spaced by a rear wall.

Preferably, the rear wall has a curved upper wall portion and a substantially planar lower wall portion.

Preferably, an inner surface of the guard is provided with at least one longitudinal rib.

Preferably, the discharge aperture has a dimension front-to-rear, in use, of from 15 mm to 25 mm, preferably from 18 to 20 mm.

Preferably, the discharge deflector guard is arranged to pivot about an operatively substantially horizontal axis adjacent an upper edge thereof.

Preferably, the discharge chute closure flap is biased by a closure force into a position whereby the outlet of the discharge chute is obstructable by the closure flap and wherein the closure force acts to hold the discharge deflector guard in position.

Preferably, the guard is dimensionally selected to provide a discharge aperture between the guard and the body of the lawnmower such that air flowing through the discharge aperture in use flows at a speed of about 5 m/s or more.

Preferably, the discharge chute has a discharge chute area and the discharge aperture has a discharge aperture area which is selected to be less than about 50% of the discharge chute area; preferably less than 25%.

### BRIEF DESCRIPTION OF THE DRAWINGS

The above and other aspects of the present disclosure will now be described in further detail, by way of example only, with reference to the accompanying drawings, in which:

FIG. 1 is a sectional view of a part of a lawnmower including a first embodiment of a discharge deflector guard in accordance with the present disclosure;

FIG. 2 is a part perspective rear view of the embodiment of FIG. 1;

FIG. 3 corresponds with FIG. 2, with the guard in an elevated position;

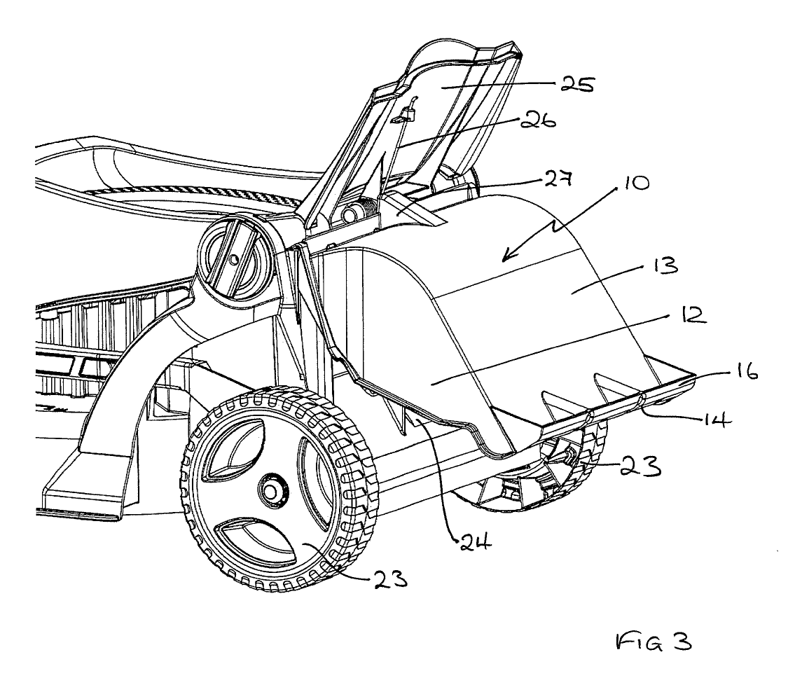

FIG. 4 is a rear perspective view of the discharge deflector guard of FIG. 1;

FIG. 5 is a front perspective view of the guard of FIG. 4; and

FIG. 6 is a sectional view, corresponding to that of FIG. 1, of a lawnmower including a second embodiment of a guard in accordance with the present disclosure.

### DETAILED DESCRIPTION

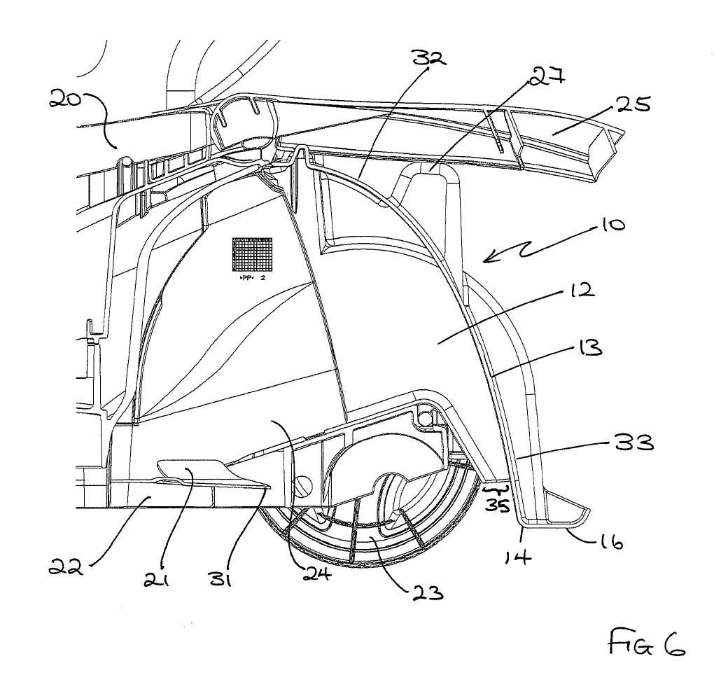

Referring to the figures, the illustrated embodiment of a lawnmower discharge deflector guard 10 typically has a pair of side walls 11, 12 spaced by a rear wall 13 which extends operatively downwards to form a skirt 14. Guard 10 is mountable to a lawnmower 20 by any suitable means, such as hooks 15 locatable on corresponding fixtures on the body of the lawnmower. Guard 10 is designed to form a substantially air/grass clipping-tight seal with a rear face of the lawnmower body, forming a discharge aperture 35 (FIG. 6) facing substantially vertically downwardly into the cut grass.

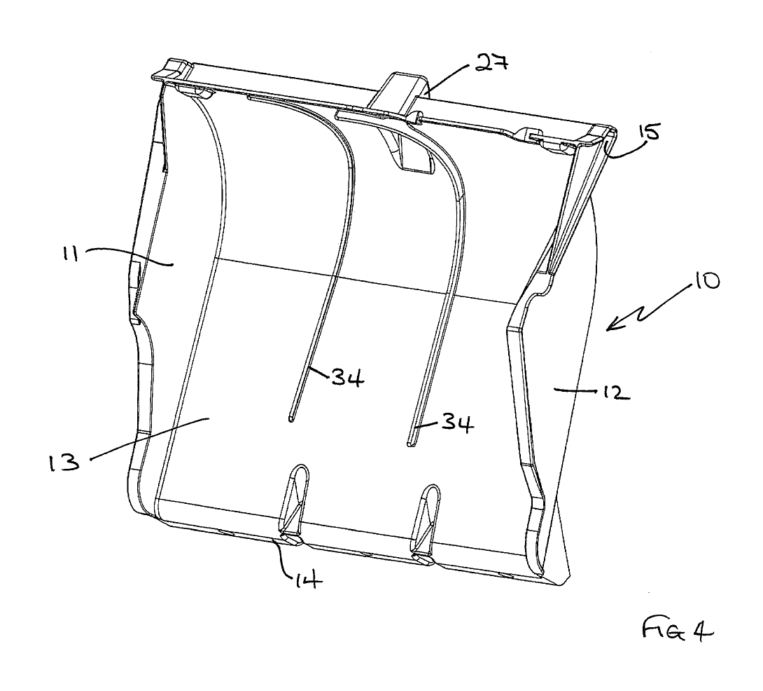

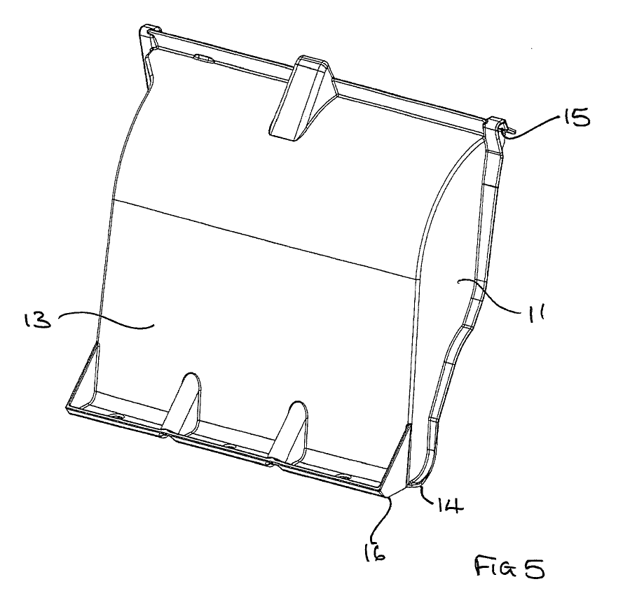

As shown in FIGS. 4 and 5, attachment points 15 are formed as deep pockets. This allows a degree of movement for the guard either up and down or rotation with respect to the lawnmower body, for example to allow the guard to swing back if it should contact the ground during turning movements when the lawnmower may be tilted backwards onto its rear wheels.

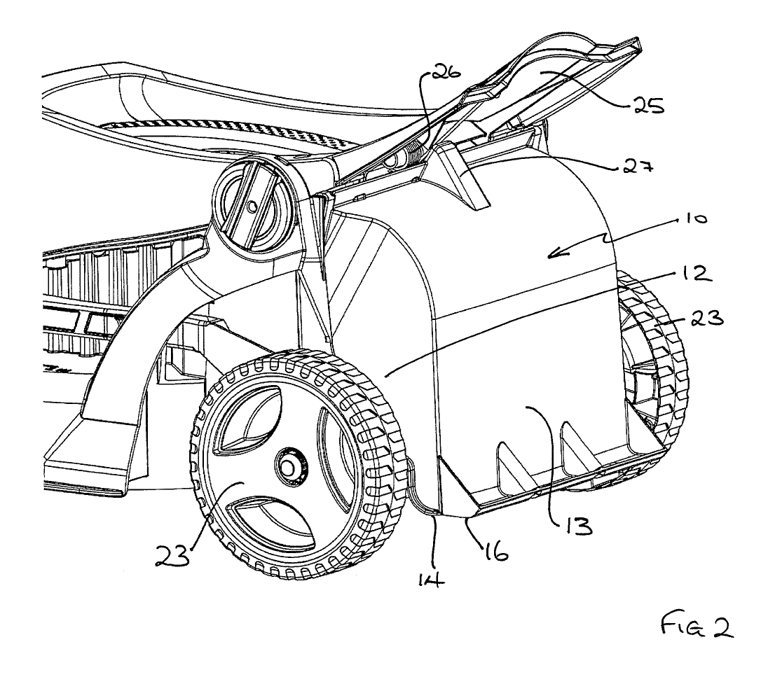

In a conventional manner, lawnmower 20 has a blade 21 mounted to the output shaft of an electric motor or petrol engine (not shown) within a cutting bowl 22 on the underside of the lawnmower 20. The lawnmower 20 is carried on wheels 23 or rollers (not shown) or a combination thereof. A discharge chute 24 is provided communicating between bowl 22 and, in a conventional walk-behind machine, a grass collection container, to collect grass cuttings produced by blade 21. The lawnmower includes a discharge chute closure flap 25 which acts, in use, to obstruct discharge chute 24 to prevent user access to the rotating blade when the lawnmower is being used without the collection container. Closure flap 25 is pivotally mounted to the lawnmower body and is biased into a closed position by means of a spring 26 (FIG. 2). In order to fit the discharge deflector guard 10 to the mower, the closure flap 25 is raised fully against its spring bias. When the discharge deflector guard 10 (FIG. 6) is in position, the closure flap 25 is released into contact with guard 10, whereby the spring bias of the closure flap provides a force to locate and retain the discharge deflector guard 10 in position.

The height of cut of the lawnmower is set by adjusting the position of the front or rear wheel pair (or both pairs) with respect to the body of the lawnmower and thus with respect to blade 21 and is thus defined by the difference between the lowermost edge 30 of wheels 23 and the cutting edge 31 of blade 21. A height of cut of about 60 mm would be typical.

Wall 13 of discharge deflector guard 10 forms a generally continuous surface with the upper wall of discharge chute 24 to enhance air/grass flow from the discharge chute to and through discharge aperture 35. In the embodiment shown, wall 13 has a generally arcuate upper portion 32 curving from the point at which it meets the body of the lawnmower adjacent discharge chute 24 to an intermediate point at which the wall continues to form a generally planar lower wall portion 33 extending to skirt 14. Alternative shapes to wall 13 are suitable. For example, the upper portion of wall 13 may comprise a pair of orthogonal substantially planar wall portions; or may include a single inclined upper wall surface, inclined with respect to lower wall portion 33. Skirt 14 may be omitted from the lower edge of wall 13.

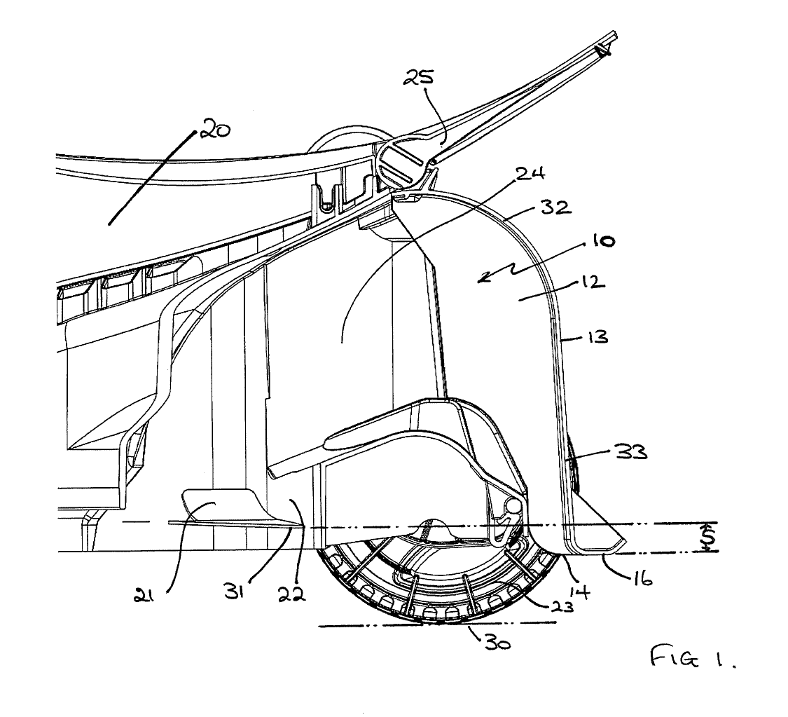

FIG. 6 shows a variation on the embodiment of FIG. 1 in which the lower portion of wall 13 is more inclined. FIG. 6 also shows closure flap 25 bearing against a projection 27 moulded into guard 10.

In order to aid forcing of grass clippings into the lawn in use, lower wall portion 33 is designed to extend below the height of cutting edge 31 of blade 21, by a separation S. In preferred embodiments S is at least 5 mm and is more preferably at least 10 mm. Values of 15 mm or more, particularly about 18 mm have been found to be especially satisfactory at forcing clippings deep into the cut sward.

It will be seen therefore that, for a typical rear discharge mower, lower wall portion 33 extends below the lower edge of the existing rear face of the mower body. The lower edge of this face is typically at or even slightly above the height of the blade cutting edge.

In the preferred embodiment shown, skirt 14 is provided with a flange 16 to provide an improved gliding movement of the guard over the lawn and thereby enhance maneuverability to the lawnmower. This is especially advantageous if the guard should make contact with the ground when the mower is tilted back on its rear wheels. In such conditions, the guard may be momentarily rotated rearwardly out of its intended position against the spring bias of closure flap 25.

As shown in FIG. 4, the internal surface of wall 13 is advantageously provided with longitudinal ribs 34. These act to modify the airflow distribution across the width of the discharge aperture 35 to optimise the uniformity of deposition of clippings into the grass sward. Such ribs project from wall 13 suitably by approximately 10 mm and run directly down the internal face of wall 13 or, as appropriate, curving partly to the left or right as required to create an even grass cuttings distribution for a particular lawnmower design.

The discharge deflector guard 10 extends across the entire width of the rear of lawnmower and forms a substantially air/grass clipping-tight seal with it, so providing improved performance over a simple discharge chute plug arrangement, providing improved spread of clippings over the cut area. The low skirt 14 forces clippings deep into the cut surface rather than merely allowing the clippings to drop onto the surface.

Discharge aperture 35 is preferably substantially elongate, suitably rectangular or generally rectangular, in shape having its long axis orientated across the width of the lawnmower and its short axis in the direction of mower travel. To achieve a good distribution of grass cuttings, the discharge aperture 35 should be at least 40% of the cutting width of the lawnmower, preferably 50% or more.

It will be appreciated that the discharge chute has a cross-sectional area, as does the discharge aperture 35 (FIG. 6) formed between the discharge deflector guard 10 and the lower rear extremity of the body of the lawnmower. The dimensions of discharge aperture 35 are preferably selected such that air is output, in use, through this aperture with an air speed of about 5 m/s or more. It will be appreciated that the input air speed will be dependent upon the air flow generated by the cutting blade and any associated fan and the area and length of the discharge chute and will thus vary from lawnmower to lawnmower. The area of the discharge aperture and thus the dimensions of guard 10 will be selected accordingly. A speed of about 5 m/s or more ensures that grass cuttings are adequately forced into the lawn. In a typical embodiment, the area of the discharge aperture is selected to be less than about 50% the area of the discharge chute; preferably less than 30% of the area. In lawnmowers having a cutting width of up to 40 cm, a ratio of discharge aperture area to discharge chute area of less than 20% has been found to be appropriate, particularly about 14%. In lawnmowers having a cutting width of 40 cm up to about 45 cm, a ratio of over 15% was found to be advantageous, especially a ratio of about 22%. Typically, this corresponds to a typical front-to-rear dimension to discharge aperture 35 of from 15 mm to 25 mm, more typically about 18 mm to about 20 mm.

What is claimed is:

1. A lawnmower discharge deflector guard for a lawnmower having a cutter blade rotatably mounted within a cutting cavity, wherein the cutting cavity is in communication with a discharge chute and having a discharge chute outlet formed in a face of the lawnmower obstructable by a closure flap, wherein the guard is configured for demountable attachment to the lawnmower adjacent the discharge chute outlet to enclose said outlet and receive, in use, grass cuttings therefrom, and wherein the guard forms a substantially air/grass cutting-tight seal with said face of the lawnmower, and wherein the guard has an operatively inner surface having a substantially vertical portion forming a discharge aperture with said face of the lawnmower and extending below a cutting height of the lawnmower.

2. A discharge deflector guard as claimed in claim 1, wherein the inner surface of the guard forms a substantially continuous surface with an upper surface of the discharge chute.

3. A discharge deflector guard as claimed in claim 1, wherein the substantially vertical portion extends to a distance S below a level of the cutter blade, wherein S is at least 5 mm.

4. A discharge deflector guard as claimed in claim 3, wherein S is about 18 mm.

5. A discharge deflector guard as claimed in claim 1, wherein the substantially vertical portion comprises a skirt having a flange at a lowermost edge thereof

6. A discharge deflector guard as claimed in claim 1, further comprising a pair of side walls spaced by a rear wall.

7. A discharge deflector guard as claimed in claim 6, wherein the rear wall has a curved upper wall portion and a substantially planar lower wall portion.

8. A discharge deflector guard as claimed in claim 1, wherein an inner surface of the guard is provided with at least one longitudinal rib.

9. A discharge deflector guard as claimed in claim 1, wherein the discharge aperture has a dimension front-to-rear, in use, of less than about 30 mm.

10. A discharge deflector guard as claimed in claim 1, wherein the guard is configured to form a substantially elongate discharge aperture having a long axis orientated across a width of the lawnmower.

11. A discharge deflector guard as claimed in claim 10, wherein the discharge aperture has a width of 40% of the cutting width of the lawnmower or more.

12. A lawnmower comprising a rotatable cutter blade mounted within a cutting cavity and a discharge chute having an inlet in communication with the cutting cavity and discharge chute outlet formed in a face of the lawnmower and obstructable by a closure flap, wherein the lawnmower further comprises a discharge deflector guard mountable adjacent the discharge chute outlet to enclose said outlet and receive, in use, grass cuttings therefrom, and wherein the deflector guard forms a substantially air/grass cutting-tight seal with said face of the lawnmower, and wherein the guard has an operatively inner surface having a substantially vertical portion forming a discharge aperture with said face of the lawnmower and extending below a cutting height of the lawnmower.

13. A lawnmower as claimed in claim 12, wherein the guard has an inner surface that forms a substantially continuous surface with an upper surface of the discharge chute.

14. A lawnmower as claimed in claim 12, wherein the discharge deflector guard is arranged to pivot about an operatively substantially horizontal axis adjacent an upper edge thereof

15. A lawnmower as claimed in claim 14, wherein the discharge chute closure flap is biased by a closure force into a position whereby the outlet of the discharge chute is obstructable by the closure flap and wherein the closure force acts to hold the discharge deflector guard in position.

16. A lawnmower as claimed in claim 12, wherein the guard is dimensionally selected to provide a discharge aperture between the guard and the body of the lawnmower such that air flowing through the discharge aperture in use flows at a speed of about 5 m/s or more.

17. A lawnmower as claimed in claim 16, wherein the discharge chute has a discharge chute area and the discharge aperture has a discharge aperture area which is selected to be less than about 50% of the discharge chute area.

18. A lawnmower as claimed in claim 12, wherein the discharge aperture has a dimension front-to-rear of between 15 mm and 25 mm.

19. A lawnmower as claimed in claim 12, wherein the discharge aperture is substantially rectangular having a long axis orientated across a width of the lawnmower.
